(19) United States
(12) Patent Application Publication
(10) Pub. No.: US 2026/0050616 A1
(43) Pub. Date: Feb. 19, 2026

(54) FINE-TUNING SYSTEM FOR LARGE LANGUAGE MODELS TRAINED FOR OPEN-ENDED DOMAIN-SPECIFIC TASKS

(71) Applicant: PAYPAL, INC., San Jose, CA (US)

(72) Inventors: Yuan Wang, Nanjing (CN); Chawannut Prommin, Singapore (SG); Guangsen Wang, Singapore (SG)

(21) Appl. No.: 18/804,869

(22) Filed: Aug. 14, 2024

(51) Int. Cl. G06F 16/332; G06F 16/383

(52) U.S. Cl. CPC G06F 16/3329; G06F 16/383

(57) ABSTRACT

There are provided systems and methods for a fine-tuning system for large language models trained for open-ended domain-specific tasks. An online transaction processor or other service provider may provide computing services and platforms to entities, which may include chatbots, information retrieval systems, question-and-answer systems, and the like. To provide better LLM training and fine-tuning, which may improve LLM performance in answering users' questions in an automated manner, the service provider may implement a fine-tuning system that may utilize automated annotations of training data, such as query and response pairs. An LLM may be prompted to determine an annotation to such pairs, and the annotations may be used to label the training data. A fine-tuning system and operations may then be implemented to fine-tune the LLMs using different processes including question-answering, retrieval augmented generation, or a continuous fine-tuning based on a size of the training data.

### TECHNICAL FIELD

The present disclosure relates generally to artificial intelligence (AI) and machine learning (ML) systems and models, and more specifically to fine-tuning of large language models (LLMs) for responding to queries and requests for domain-specific tasks.

### BACKGROUND

LLMs are widely used in enterprise applications due to their generalized nature language processing (NLP) capabilities. However, LLMs may lack domain-specific knowledge and thus Retrieval Augmented Generation (RAG) may be used to provide domain-specific context as a part of an input to LLM, which may assist LLMs with responding based on the provided context rather than using internal knowledge of the LLMs. LLM fine-tuning (FT) may also be used to improve LLM performance where RAG may not provide sufficient improvements to accuracy. However, FT of LLMs presents many obstacles. Sufficient annotated data may be the first barrier for FT of LLMs on domain-specific tasks. For example, the quality of human annotation in training data during curation may vary because annotation is often done by crowdsourcing or a dedicated annotation team, where different people may provide different annotations. As such, for open-ended tasks where the correct answer is not unique, different annotators may annotate a ground truth answer differently. Further, it may be required to ensure each annotation strictly uses the context information instead of common knowledge with human understanding. When the ground truth answer is annotated based on ‘common sense,’ responses from LLMs may incur “hallucinations” in a fine-tuned model if those annotations are not filtered from the training data. Thus, detecting hallucinations introduced by human annotation at scale presents a significant challenge during training data curation.

Additionally, the volume of training data to curate for FT is another challenge. It is commonly known that a certain amount of training data is required for FT, and curation of such volume of data is both time consuming and costly, especially for open-ended domain-specific tasks. FT often requires the model to be “white box,” i.e., the model architecture and model weights are available to developers. However, many vendor solutions, such as OpenAI™ and Google PaLM2™, may instead offer black-box application programming interfaces (APIs) for FT which hinders their usability for existing FT. Further, LLM model performance after training scales with more data and more computation power. However, for a given budget in commercial settings, the data and hardware resources may constrain training and FT. As such, it is desirable to tailor a FT system adaptive to different training data conditions, as well as measure hallucinations of a fine-tuned model's response in open-ended domain-specific tasks. Therefore, there is a need for an automated, intelligent, and efficient FT system and framework for LLMs that respond to domain-specific tasks, which improves LLM efficiency and accuracy, while reducing operational costs and computing resource usage.

### BRIEF DESCRIPTION OF THE DRAWINGS

FIG. 1 is a block diagram of a networked system suitable for implementing the processes described herein, according to an embodiment;

FIGS. 2A-2B are exemplary diagrams of a service provider's systems that provide FT processes for LLMs through automated data curation and augmentation, according to an embodiment;

FIGS. 3A-3D are exemplary diagrams of data curation and augmentation for an LLM FT system and framework, according to various embodiments;

FIG. 4 is a flowchart of a fine-tuning system for large language models trained for open-ended domain-specific tasks, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for a fine-tuning system for large language models trained for open-ended domain-specific tasks. Systems suitable for practicing methods of the present disclosure are also provided.

A service provider, such as an online transaction processor, may provide computing services to users and/or their corresponding entities, which may include end users and customers, merchant customers of an online transaction processor, businesses and their representatives and/or employees, and the like. These computing services may include those associated with electronic transaction processing, payments, digital account usage, peer-to-peer transfers and payments, and the like. With these computing services, automated help or assistance may be provided through chatbots in an email channel, a digital alert channel, a text message channel, a push notification channel, an instant message channel, or the like. These chatbots and other automated computing processes may allow end users of a service provider to engage in self-service assistance options associated with one or more services of the service provider. For example, an online transaction processor may provide automated assistance options for account setup, authentication, account usage (e.g., during electronic transaction processing), mobile device or application usage, payment information and/or service, and the like. These automations for self-service options provide assistance via chat sessions and automated chat dialogs and other communication through different electronic communication channels. A conversational AI platform or system may be used to converse with users, which may include LLMs, Retrieval Augmented Generation (RAG) bots, ML models, NNs, and other AI systems for conversing with users. For example, an LLM may be used to respond to users in a conversational manner, where RAG-based bots and operations may retrieve domain-specific documents and/or information for a specific context to steer responses of the LLM to certain domains and knowledge.

Conversations between chatbots and users during chat sessions may include users submitting questions or requests, such as by querying or commanding the chatbots, and receiving corresponding answers or responses. However, LLMs are generalized in nature and respond from an initial corpus of documents used to provide their NLP capabilities.

To provide improved fine-tuning of LLMs, an LLM FT system, in some embodiments, may be provided and/or utilized by the service provider, which may be usable with both white box and black box models. The FT system may adjust according to training data size to further boost model performance while reducing the volume prerequisite of training data annotation by means of data augmentation. The FT system may utilize a hallucination metric to measure a presence and severity (e.g., importance, reliance when providing a response, etc.) of a given data sample in an LLM generated response or a human annotated response. For example, the hallucination metric may provide or be used to determine a reasoning as to why the data is labeled as a hallucination or incorrect response while relying on data outside of the domain-specific scope or context of the query, domain, and/or knowledge base. This metric serves two purposes, first, to automatically filter out hallucinations introduced during human annotation and at scale; and second, as an automatic metric to measure responses from a fine-tuned LLM model in open-ended applications for correctness and/or reliance on domain-specific knowledge instead of hallucinations outside of the context of the domain.

In this regard, LLMs and LLM chatbots may be used with the different computing services provided by a service provider, such as to provide automated customer service during computing service usage. In order for users to utilize computing services of the service provider, the service provider (e.g., an online transaction processor, such as PAYPAL®) may require users and other entities requesting the services to have an account with the service provider. A user wishing to establish an account may first access the online service provider and request establishment of the account. When establishing accounts, login and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments. Further, the user may stablish, purchase, trade, and/or store cryptocurrency (e.g., through storage, exchange, and/or use of private keys for cryptocurrency values, tokens, or digital currency).

The user may also be required to provide financial information, including payment card (e.g., credit/debit card) information, bank account information, gift card information, benefits/incentives, and/or financial investments, which may be used to process transactions for items. The account creation may be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of a user is established with the service provider, the user may utilize the account via one or more computing devices, such as a personal computer, tablet computer, mobile smart phone, or the like. The user may engage in one or more online or virtual interactions that may be associated with electronic transaction processing, images, music, media content and/or streaming, video games, documents, social networking, media data sharing, microblogging, and the like. Similarly, the merchants may use the accounts when providing their merchant services to customers, such as during electronic transaction processing. As such, different users may engage in one or more online or virtual interactions, such as browsing websites and data available with websites of merchants. In this regard, the transaction processor or other online service provider may offer and provide computing services through data processing of account and transaction data for electronic transaction processing, as well as other data processing services for other use of computing services on websites, applications, or other online portals of the merchant.

In this regard, a service provider may provide an autonomous agent and/or chatbot to assist users with computing service usage and enhance the efficiency of various analytical tasks during assistance and/or automated conversational usage of computing services. These automated chatbot systems may rely on LLMs, which may provide conversational responses to users. To provide more accurate LLMs and chatbots, the service provider, in some embodiments, may fine tune these systems with domain-specific knowledge and data (e.g., corpora of documents, such as training and/or FT documents), especially with open-ended tasks in certain domains. In this regard, the FT system may correspond to a fine-tuning training pipeline consisting of three or more main components. These components may include metrics for LLM FT assessment, procedures for training data curation and augmentation, and an LLM FT training scheme adaptive to training data size. Initially, two LLM “agents” or LLM automated bot systems and/or applications may interact. The first, “Agent 1,” may execute a candidate LLM prompt to an LLM, such as to prompt or question the LLM for a response, with an input data sample that produces an LLM hallucination performance, such as a question designed to elicit a response that includes a hallucination or an answer outside the scope of the question and incorrect or disconnected from the input prompt. The second agent, “Agent 2,” may read the hallucination accuracy produced by Agent 1 and iteratively optimize the prompt with optimization objectives to produce higher hallucination accuracy. This approach leverages the LLM prompting strategy of a “few-shot examples” with specific hallucinations that might occur during customer service interactions of the specific service provider, tenant or customer of the service provider, or other company and/or organization.

Optimizations may be provided by various prompting techniques, such as evoking emotional responses, threading conversations for context, or using chain-of-thought (CoT) processes (e.g., by structuring the input prompt in a manner that mimics human reasoning), which may help boost the accuracy of hallucination detection. More specifically, in an offline process, Agent 1 may have access to a Python (or another programming and/or code language) library and/or computing code that enables Agent 1 to evaluate the results of prompting an LLM with a prompt programmatically and adjust the prompt for the next iteration. As such, this may not require a rigid and traditional human reviewer role. Agent 2 may then examine the process from an end-to-end perspective, iterating and refining the process by leveraging new and/or different prompting techniques. For example, Agent 2 may not just be involved in adjusting the content but may also adjust the processes and parameters of the prompting techniques, allowing for a more holistic optimization of the prompts.

Once prompts have been optimized, a data sample in the form of query, context, response or other format may be fed into LLM with and/or using the optimized prompt produced from the aforementioned offline process using the dual agent framework. Prompting the LLM may result in obtaining an intermediate reasoning response from the LLM, such as a CoT output. Another LLM may process the CoT output to provide a final decision, such as a binary label, severity score, and reasoning or the like on the effectiveness and/or accuracy of the response to the query given the context of the query (e.g., the open-ended domain-specific task). To reduce human annotation efforts and improve diversity and volume of the training data, a data processing pipeline may be utilized to automate annotation of the response to the query given the context. For example, instead of asking the annotator to annotate every response according to the user query input and domain-specific context, the data pipeline instead may use a LLM with RAG to generate responses automatically. An annotator is then asked to label ‘YES’ or ‘NO’ based on correctness of the generated LLM response for the annotation.

As such, annotating automatically using the LLM with RAG may vastly reduce human annotation effort by providing the annotator with the ‘about right’ response. The annotator then needs only to amend the response from the LLM (e.g., the annotation) when the response is not correct instead of writing a new response every time. After response generation, data sampling and augmentation may be performed with an aim to further reduce a volume of human annotation by procedural and programmable synthesis of more data samples, such as further responses and annotations. Sampling ensures that a sufficient data distribution is covered. For example, data points may be sampled based on an intent of a query to mimic a distribution of actual online traffic. Augmentation may ensure diversity in the response and annotations, as well as covering missing scenarios from human annotated data, as augmentation may be used to augment the data to cover query diversity, context diversity, and response diversity.

To perform these processes for augmentation, the original user query may be rephrased and expanded to improve diversity. This is achieved by utilizing the LLM, for example, to generate different but similar queries given a context and query provided to the LLM. As such, response augmentation may enhance robustness and limited or “corner” case handling of FT the LLM after training. Augmentation may also generate negative samples and CoT samples for a given input to the LLM in the form of (prompt, query, context, response), such that in addition to the original response, new samples with responses are generated and added into the training dataset. Context augmentation may be used to train FT models to handle imperfect RAG results, which may also improve extraction of relevant segments for the context in a response to the user query. For a given LLM input in the form of (prompt, query, context, response), new samples may be generated in addition to the original sample, where the context may be modified while keeping other inputs the same. After these steps, the FT training data has been curated (prompt, query, context, response, label), and is ready to be consumed by the FT training scheme.

The FT pipeline may also include one or more processes for generating RAG finetuning data without human annotation by utilizing domain documents (e.g., a domain knowledge basis) for a best document and topic coverage. This may be referred to as doc2query augmentation where, for a given document/context, both queries and responses may be generated at the same time automatically. The FT system and pipeline may identify question and answer pairs in domain-specific documents through metadata analysis or by engaging with language models designed for questioning. A source document for these pairs may be labeled as a “gold” document or other label indicating a source or best matching type of document. Fror example, a gold document may correspond to a source document for generating a question and/or answer, where the gold document may be considered the “best” or most accurate document to answer a question. A document retrieval system may be used to locate the top-n most pertinent documents based on the well-formed questions to the LLMs, such as questions that may be formed from the gold or source documents. LLMs may then be utilized to formulate user-style queries from the well-crafted questions, incorporating potential spelling and grammatical deviations to enhance the variety of the data retrieved. Further, contrasting RAG data sets may be generated depending on whether the gold document is found among the top-n results. For example, if the gold document is found, then positive RAG sets may be formed in the form of (question+user-style queries, answers, the documents retrieved as context). If not, negative RAG sets may be formed in the form of (question+user-style queries, standard response indicating lack of context, the documents retrieved as context). Either or both of these RAG sets may be used for LLM FT.

Thereafter, a FT scheme and training process may be implemented, which may include question-answer (QT)-FT, RAG-FT, and/or continuous-FT. To train, the total training data size may be analyzed and compared to a threshold. If the total training data size is less than a predefined threshold, the LLM is trained using question-and-answer (QA)-FT first, then apply RAG-FT on top of the QA-FT checkpoint. This training may reduce a hallucination rate effectively. If the total training data size is larger than a predefined threshold, then applying RAG-FT in a continuous training manner may be used. During such training, each iteration of the training is determined using subset of the training data. The first round of training uses original samples where no augmentation samples are used. The second round of training uses augmentation samples on top of the first round of training. The last round of training, which may be optional, may seek to enhance “critical” samples from the training dataset. The critical samples may be defined per business or rule definition; for example, legal teams may require certain queries to be answered in specific format and tone, which are considered as critical samples.

As such, the intelligent LLM FT framework and system may provide a more efficient, automated, and accurate FT of LLMs for document retrieval and/or question answering in chatbot systems and environments. This system may automate the process to annotate data and responses, as well as generate responses with annotations, thereby bypassing much of the needed manual efforts and review, which is time consuming, costly, and prone to error. As such, LLMs may be fine-tuned in a more efficient and faster manner, resulting in more accurate LMs and automated conversational AIs. This allows for coordinated communications between different system components to improve automated chatbot systems.

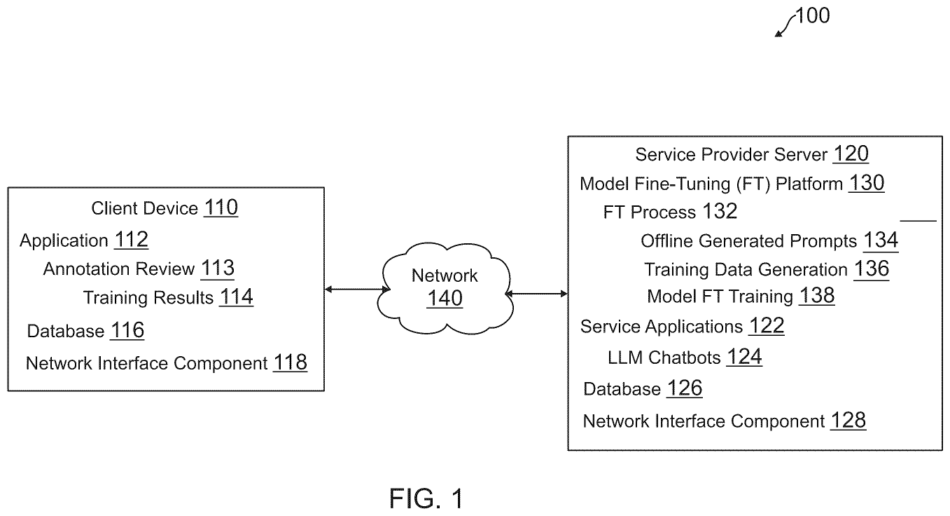

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by an entity or a user (including merchants, end-users, businesses, etc.), such as a customer of service provider server 120, to receive communications over network 140, where service provider server 120 may provide various data, operations, and other functions over network 140 to provide services to merchants, users, and computing devices. In this regard, client device 110 may be used with various chatbots and conversational AIs that may utilize LLMs that have been fine-tuned using an LLM FT pipeline and system of service provider server 120, as discussed herein.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device of an investigator, agent, or other internal user associated with service provider server 120. Client device 110 may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. The application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for an internal user, data scientist, and/or administrator for use with service provider server 120, such as to provide access to and management of computing services provided by service provider server 120 (e.g., for use of and/or interaction with the computing services of service provider4 server 120, which may include chatbots and conversational AIs). In this regard, application 112 may correspond to specialized software utilized by a user of client device 110 to generate and transmit a request for LLM FT, such as to fine-tune an LLM used by one or more chatbots or other conversational AI systems. In some embodiments, the request may specify an LLM, as well as any open-ended domain-specific tasks for LLM FT. Application 112 may also be utilized to review and address responses to LLM FT, such as when performing an annotation review 113 to review, revise, and/or provide feedback on Al generated annotations by service provider server 120. In this regard, annotation review 113 may request that a user provide feedback of whether annotations using a FT pipeline and system are correct, identify correct documents, include hallucinations, or are otherwise helpful and useful or not. After LLM FT, training results 114 may be provided to application 112, which may allow the user to review the results of LLM FT and training. As such, training results 114 may provide information regarding identified or used responses and the like based on provided queries and contexts to the fine-tuned LLM(s).

Application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other examples, application 112 may include a dedicated application of service provider server 120 or other entity that may interact with service provider server 120 during LLM FT. Thus, application 112 may also correspond to different service applications and the like. When utilizing application 112 with service provider server 120, application 112 may transmit a request for LLM FT and receive responses to such prompts, questions, or queries for an LLM, contexts, responses, annotations, documents, and the like.

Client device 110 includes other applications as may be desired to provide features to client device 110. For example, these other applications may include security applications for implementing client-side security features, programmatic client applications for interfacing with appropriate application programming interfaces (APIs) over network 140, or other types of applications. Other applications on client device 110 may also include email, texting, voice and IM applications that allow a user to send and receive emails, calls, texts, and other notifications through network 140. In various embodiments, the other applications may include those that may be utilized in the course of LLM training, training data curation and/or annotation, and/or LLM FT. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider server 120.

Client device 110 includes at least one network interface component 118 adapted to communicate with service provider server 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide computing services and operations via one or more digital platforms, applications, websites, and the like. Service provider server 120 may provide computing services to various entities, which may include computing services provider to internal and/or external users. As such, during the course of service provision, service provider server 120 may provide automated operations for conversational chat sessions using chatbots that utilize LLMs having been fine-tuned using an LLM FT pipeline and system. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes and/or is associated with a model FT platform 130, service applications 122, a database 126, and a network interface component 128, implementations of which are discussed further below. Model FT platform 130 and service applications 122 may correspond to executable processes, procedures, and/or applications with associated hardware. In other embodiments, service provider server 120 may include additional or different modules having specialized hardware and/or software as required.

Model FT platform 130 may correspond to one or more processes to execute modules and associated specialized hardware of service provider server 120 to provide an FT processes 132 that may include one or more applications, operations, and/or components that may fine-tune LLMs for chatbots, conversational AIs, and other AI components that may be used for automated conversational service by service provider server 120 with service applications 122, such as those provided through LLM chatbots 124. In this regard, model FT platform 130 may correspond to specialized hardware and/or software used by an internal agent, data scientist, administrator, or other user associated with client device 110 to perform LLM FT. For example, model FT platform 130 may receive a request from client device 110 for LLM or another conversational AI FT of one or more of LLM chatbots 124 and their corresponding model and process the request using the framework of service provider server 120. Based on the request, model FT platform 130 may provide a FT of the LLM, conversational AI, and/or another chatbot feature and processes to respond to prompts, requests, questions, queries, or other statements through annotation generation and FT model training. Model FT platform 130 may provide FT processes 132 through one or more interfaces that may be used for model training, FT, and other optimizations. As such, data scientists and other model training teams may train LLMs for LLM chatbots 124, including one or more LLMs, AI or ML models, NNs, conversational AIs, or the like. LLM chatbots 124 may correspond to LLMs or other AI models, including conversational AIs, which may include trained layers based on training data and selected features or variables configured to generate conversation or dialogue for chat assistance, such as when using or requiring assistance for service applications 122. For example, ML features may correspond to individual pieces, properties, characteristics, or other inputs for an ML model and may be used to cause an output by that ML model once the ML model has been trained using data for those features from training data. LLM chatbots 124 may be used for intelligent conversational outputs based on training on a set of documents, such as one or more corpora of general and/or domain documents. As such, ML models including LLMs may be trained to provide predictive outputs, such as a response, score, likelihood, probability, or decision, associated with a particular prediction, classification, or categorization.

For example, LLM chatbots 124 may include deep neural networks (DNNs), MLs, generative AIs, LLMs, or other AI models trained using training data having data records that have columns or other data representations and stored data values (e.g., in rows for the data tables having feature columns) for the features. When building LLM chatbots 124, training data may be used to generate one or more classifiers and provide recommendations, predictions, or other outputs based on those classifications and an ML or NN model algorithm and architecture. For example, with LLMs, training data may correspond to different corpora of documents and information, which may then allow the models to respond intelligently based on learning for such corpora. The algorithm and architecture for the LLM chatbots 124 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records. Thus, when the LLM chatbots 124 are used to perform a predictive analysis and output, the input data may provide a corresponding output based on the trained classifications.

Layers, branches, clusters, or the like of the LLM chatbots 124 may be trained by using training data associated with data records of interest, such as general or domain-specific documents. This may include domain knowledge based on and/or domain documents for the computing service provided and/or managed by service provider server 120 including one or more of service applications 122. In this regard, for training LLM chatbots 124, corpora of documents associated with general knowledge documents and/or domain-specific documents. By providing training data, the nodes in the hidden layer may be trained (adjusted) such that an optimal output (e.g., a classification) is produced in the output layer based on the training data. By continuously providing different sets of training data and/or penalizing the LLM chatbots 124 when the outputs are incorrect, the LLM chatbots 124 (and specifically, the representations of the nodes in the hidden layer) may be trained (adjusted) to improve its performance in data classifications and predictions. Adjusting of the LLM chatbots 124 may include adjusting the weights associated with each node in the hidden layer.

Adjusting LLM chatbots 124 may also include retraining and/or FT of the corresponding LLMs, such as by using FT processes 132. FT processes 132 may include generating and utilizing offline generated prompts 134, which may be used for annotation creation and generation by LLMs in place of manual and/or human efforts and annotations. Offline generated prompts 134 may be generated using a dual or multi-LLM agent process and framework, where different LLM agents interact to optimize prompting techniques that seek to prompt LLMs for annotation generation of training data, where the training data may include queries, contexts to the queries and/or domains of the queries, and responses by LLM chatbots 124 or other chatbots to those queries. As such, offline generate prompts 134 may then be used by a training data generation 136 during annotation of the training data to create a set of training data having annotations for model FT. Training data generation 136 therefore seeks to curate, annotate, and/or augment initial training data with annotations for better model FT. Once the training data is annotated and generated by training data generation 136, model FT training 138 may utilize the annotated training data to fine tune LLM chatbots 124 and/or other LLMs. Model FT training 138 may be performed based on a size of the training data and annotations, as well as a threshold for different training schemes and operations. Model FT training 138 may therefore assist in training and/or FT LLM chatbots 124 for better accuracy and improved reliability (e.g., less hallucinations) when responding to user queries for open-ended domain-specific tasks, such as those assistance or other service tasks associated with service applications 122.

Service applications 122 may correspond to one or more processes to execute modules and associated specialized hardware of service provider server 120 to process a transaction and/or provide other computing services to users. For example, service applications 122 may be used to process payments and other services to one or more users, merchants, and/or other entities for transactions, where model FT platform 130 may be used for model FT of LLMs utilized by and/or provided through LLM chatbots 124. In this regard, accounts of users and entities may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations.

Further, service applications 122 may provide different computing services, including social networking, microblogging, media sharing, messaging, business and consumer platforms, etc. These computing services may be used by customers and users, and therefore LLM chatbots 124 may be used to provide assistance and other conversational services utilized during the provision of computing services to users and devices. In this regard, LLM chatbots 124 may answer queries and questions from users by providing responses based on a context, where the responses may be domain-specific and based on open-ended tasks and requests. As such, FT processes 132 may be used for FT of LLM chatbots 124 to provide more accurate and reliable responses with less hallucinations including responses that rely on and/or identify domain-specific documents (which may include “gold” or best identified documents for specific queries and tasks).

Service applications 122 as may provide additional features to service provider server 120. For example, service applications 122 may include security applications for implementing server-side security features, programmatic client applications for interfacing with appropriate APIs over network 140, or other types of applications. Service applications 122 may contain software programs, executable by a processor, including one or more GUIs and the like, configured to provide an interface to the user when accessing service provider server 120, where the user or other users may interact with the GUI to view and communicate information more easily. Service applications 122 may include additional connection and/or communication applications, which may be utilized to communicate information to over network 140.

Additionally, service provider server 120 includes or may access database 126. Database 126 may store various identifiers associated with client device 110. Database 126 may also store account data, including payment instruments, financial information, account balances, and authentication credentials, as well as transaction processing histories and data for processed transactions. Database 126 may include information used during AI conversational service provision by LLM chatbots 124 and the like, such as domain documents for open-ended domain-specific tasks. Although database 126 is shown as residing on service provider server 120 as a database, in other embodiments, other types of data storage and components may be used including cloud computing storage nodes, remote data stores and database systems, distributed database systems over network 140 and/or of a computing system associated with service provider server 120, and the like.

Service provider server 120 may include at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

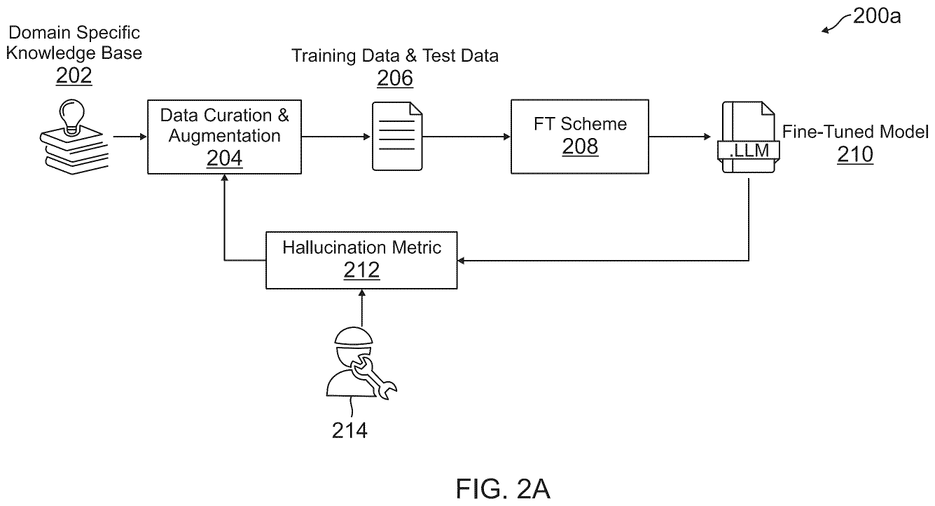

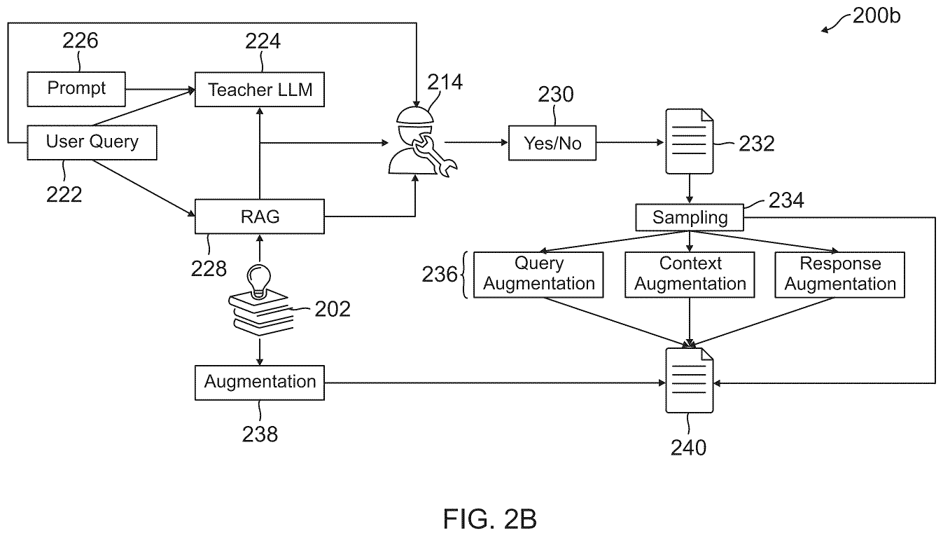

FIGS. 2A-2B are exemplary diagrams 200a and 200b of a service provider's systems that provide FT processes for LLMs through automated data curation and augmentation, according to an embodiment. Diagrams 200a and 200b may include components of service provider server 120 that may be utilized by client device 110 for fine-tuning (FT) of LLMs using automated approaches and without or with minimal human annotations and efforts, as discussed in reference to system 100 of FIG. 1. In this regard, diagrams 200a and 200b show determinations of hallucination metrics and training data curation and augmentation to minimize hallucinations and provide FT of LLMS.

In diagram 200a of FIG. 2A, a system is shown that may generate training data, as well as detect and measure a hallucination of or in a data sample (e.g., a query, context, response set), using an LLM as evaluator. This may include an offline and an online process, which may be combined to annotate data and eliminate or minimize hallucinations in LLMs after LLM FT. In this regard, a domain-specific knowledge base 202 may be processed using a data curation and augmentation 204 for training data and test data 206. The processes for data curation and augmentation 204 is discussed in further detail below with regard to FIGS. 2B-4. Once training data and test data 206 is generated, a FT scheme 208 may be applied and utilized to FT an LLM, such as one used by LLM chatbots 124 from system 100, to converse with users and provide responses to open-ended domain-specific tasks, such as queries and questions with regard to a specific domain (e.g., a domain that may require automated customer service and/or QA.

As such, a fine-tuned model 210 may be generated after the FT of an LLM using training data and test data 206 with FT scheme 208. However, to determine a severity of hallucinations, a hallucination metric 212 may be calculated, where a user 214, such as a data scientist, may review and further annotate data for hallucination identification. For example, hallucination metric 212 may be determined based on the reliance of a “gold” or source document used for answering a question, where if the source document is not used or among the top-n documents, the response may indicate a hallucination. Further, user 214 may review annotations and select “Yes” or “No” as to whether the annotations are correct or indicate a hallucination; however, other automated and/or intelligent processes may be used include text and/or LLM analysis of the annotations. Based on any detected hallucinations and hallucination metric 212 for training data and test data 206, further filtering of bad annotations may be performed so that data curation and augmentation 204 on domain-specific knowledge base 202 may proceed to further refine training data generation.

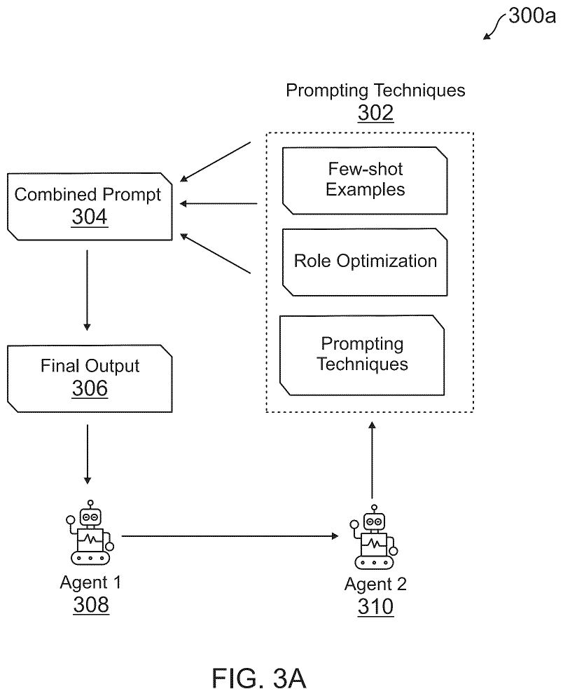

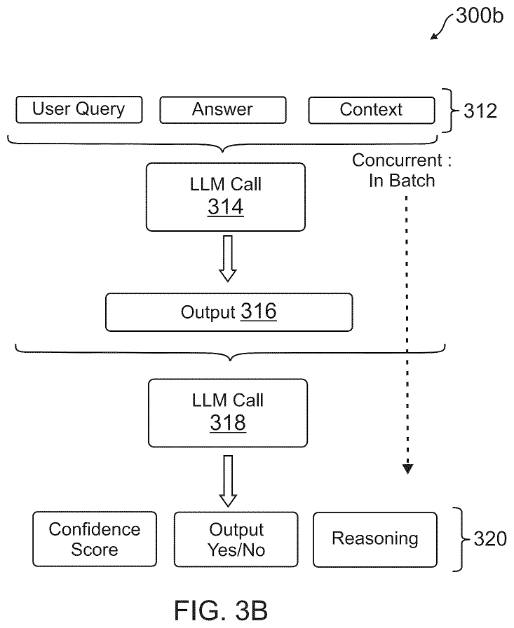

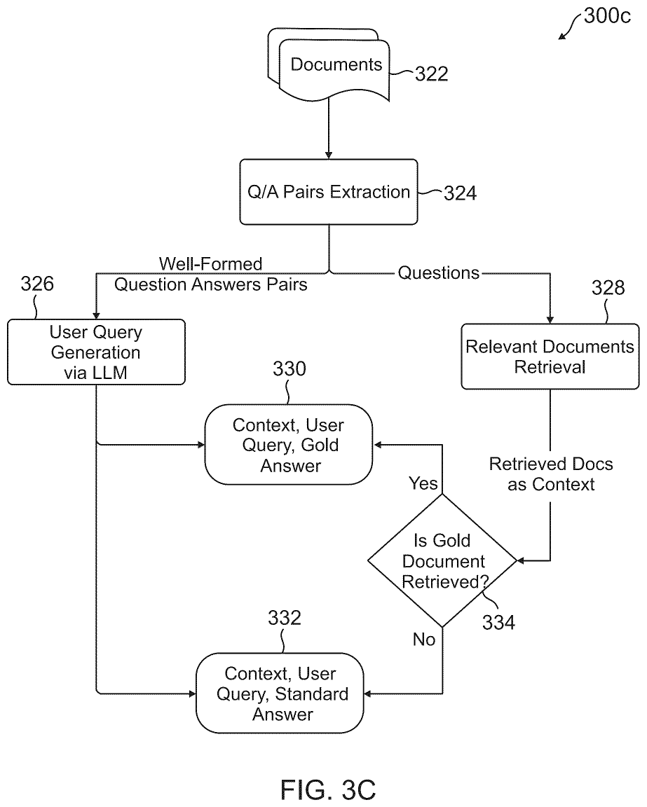

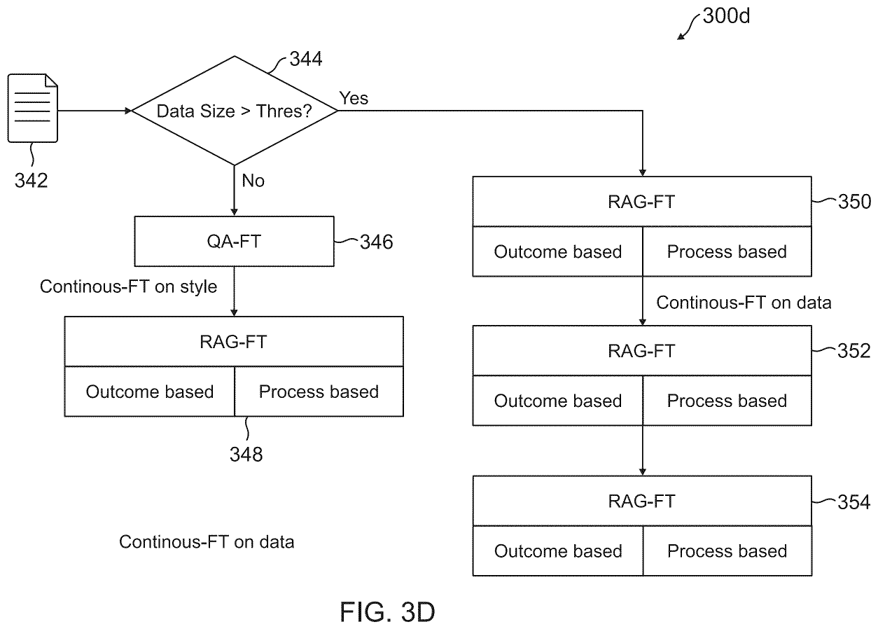

In diagram 200b of FIG. 2B, data curation and augmentation 204 on domain-specific knowledge base 202 is shown in further detail. In this regard, diagram 200b shows two different processes for generating training data 240, such as using different procedures and operations for training data generation. For example, in a first process, instead of having a user annotate every response according to their query and domain, an LLM with RAG may be asked to generate responses automatically. This may be performed using prompts, where the prompts may be generated using an offline process shown in FIG. 3A and described below. Once prompt generation is completed, domain-specific knowledge base 202 may be processed for annotation and training data generation. For example, a user query 222 may be provided to a teacher LLM 224 using a prompt 226, where teacher LLM 224 may utilize a RAG process 228 to generate an annotation to a corresponding response to user query 222 depending on the context of user query 222. User 214 may then be asked to label the correctness of the generated LLM response, which reduces the need for users to generate annotations alone and provides an “about right” response that user 214 may only need to amend if the response is not correct.

As such, a response label 230 is provided with the LLM generated annotation to user query 222, where an initial training data set 232 in the form of (prompt, query, context, response, label) may be generated for each query-response pair in the initial data set. As such, the query-response pairs of the data set may now be annotated. A data sampling 234 may be performed to ensure that a sufficient data distribution is covered, such as by sampling data pairs or points based on the intent of the query and/or mimicking distribution of online traffic. A data augmentation 236 may be performed, which may ensure diversity among the annotations and training data set, as well as provide any missing scenarios. As a result, training data 240 may be generated with data samples having a prompt, query, context, response, and label from annotation, sampling, and/or augmentation.

With a second process, an augmentation 238 may be applied to domain-specific knowledge base 202, such as a doc2query augmentation, where training data 240 may result from generation of queries and responses automatically. This may be done by identifying query-response (or question-answer) pairs in domain-specific documents through metadata analysis and/or using an LLM. Further, this may include generating contrasting RAG data sets for the query-response pairs and training data based on whether queries result in a document retrieval system retrieving a source document from each of the queries. The first process and second process are further shown in FIGS. 3B and 3C and described below.

FIGS. 3A-3D are exemplary diagrams 300a-300d of data curation and augmentation for an LLM FT system and framework, according to various embodiments. Diagrams 300a-300d include processes to FT an LLM using annotated training data that may be generated by model FT platform 130 of service provider server 120 in system 100 of FIG. 1. As such, diagrams 300a-300d show processes by which training data and annotations may be automatically created without or with minimal human efforts through LLM prompting and analysis of domain-specific documents and other data for open-ended tasks.

Referring now to diagram 300a of FIG. 3A, an offline process for prompt generation that may be used when generating training and/or FT data for FT of an LLM is shown. In this regard, two LLM agents may interact to generate and/or evaluate and refine prompting techniques 302 for prompting an LLM to generate annotations and/or identify hallucinations in generated annotations. Prompting techniques 302 may be used for creation of a combined prompt 304 that may result from multiple different usages of prompting techniques 302 for prompting an LLM. A final output 306 may correspond to a response or other output from the prompt and/or prompt template of combined prompt 304 used to prompt an LLM, where combined prompt 304 may be used for LLM prompting when performing annotation generation and hallucination identification and/or scoring in annotated query-response pairs for LLM FT.

To perform this process an agent 1 308 and an agent 2 310 may interact together, where agent 1 308 executes a candidate prompt with an input data sample to produce a hallucination performance and agent 2 310 reads the hallucination and iteratively optimizes the data from final output 306 to optimize the objectives of prompt generation, such as to product higher accuracy and less hallucinations. In this regard, a prompt with a “few-shot examples” of hallucinations that may occur in customer service or other domain for an LLM chatbot may be used, as well as other prompting techniques including evoking emotional responses, threading conversations for context, and/or CoT processes. Agent 1 308 may programmatically generate and evaluate the response of final output 306 to combined prompt 304, which may be provided to agent 2 310. Agent 2 310 may then examine the process, such as from an end-to-end perspective, and iterate over the process to refine combined prompt 304 through prompting techniques 302 for better hallucination accuracy with final output 306. As such, agent 2 310 may adjust not just content but also the parameters of prompting techniques 302.

Referring now to diagram 300b of FIG. 3B, after the offline process of FIG. 3A, an online process of measuring hallucination may be performed based on responses to queries. A data sample 312 in the form of (query, context, response) may be fed into the LLM via an LLM call 314 together with the optimized prompt produced from the offline process in FIG. 3A. The LLM may then produce an intermediate reasoning response, such as a CoT output 318, which may be used as an annotation to the training data (e.g., whether the response to the query given the context includes a hallucination or is otherwise accurate/inaccurate). Another LLM may then be used to process the CoT output and provide or issue a final decision 320, such as a binary label, severity score and reasoning, or the like for any hallucinations in the initial data sample. This may then be used for LLM FT in the FT training data set.

Referring now to diagram 300c of FIG. 3C, another online process for generating RAG or other FT data without human annotations is shown. The process in diagram 300c may include utilizing documents 322, such as in-house, domain, and/or proprietary documents for document coverage. Initially, QA pairs 324 may be identified and generated through analysis of documents 322 with a use of metadata and/or LLMs designed for questioning. A source document for each of these pairs may be identified. Thereafter, a user query generation via LLM 326 may be performed where LLMs may formulate user-style queries from the question of QA pairs 324. This may include generation queries having spelling and grammatical changes and deviations but that are rooted in the corresponding answers. For the questions, a relevant documents retrieval 328 is performed to retrieve the “relevant” or most accurate/matching documents (e.g., as measured based on content and/or use in answering questions), such as a top-n most relevant documents, to each question. For example, the top-n documents that are most pertinent to these questions are determined. Thereafter, for the newly formulated questions from user query generation via LLM 326, contrasting RAG data sets are generated. Where the “gold” or source document from relevant documents retrieval 328 is among the documents retrieved for the question, then positive RAG sets are formed as (well-formed question+user-style queries, gold answers, the documents retrieved as context). However, if the gold or source document is not found from relevant documents retrieval 328 for the question, negative RAG sets are formed as (well-formed question +user-style queries, standard response indicating lack of context, the documents retrieved as context).

Referring now to diagram 300d of FIG. 3D, training data 342 that has been generated, curated, and augmented with annotations is shown being processed and utilized for fine-tuning and other training of an LLM. Initially, training data 342 is compared to a data threshold 344 and a determinate made whether the training data is below, meets, or exceeds such a threshold. Data threshold 344 may be selected based on performance of the fine-tuning and training schemes selected for LLM fine-tuning. For example, in some embodiments, a threshold size of 3000 training data samples may be used; however, this number may be configured as needed and/or for performance of the FT system. If the total training data size of training data 342 is less than or equal to data threshold 344, the LLM may be trained and fine-tuned using QA-FT 346 based on the data samples of (prompt, query, response). Thereafter, a continuous-FT 348 may be applied using RAG-FT based on data samples of (prompt, query, context, response), which may include outcome-based training and process-based training.

However, if the total training data size of training data 342 is greater than or equal to data threshold 344, to the training of the LLM uses a style of RAG-FT that may utilize a continuous training with multiple iterations, each iteration using a different subset of training data 342 for FT and other training. In this regard, a first RAG-FT 350 may be used to fine-tune the LLM using an original sample where no augmentation is used for annotations and/or hallucination measurement. In a next iteration, a second RAG-FT 352 may perform fine-tuning and other training using data samples with augmentation on top of the fine-tuning of first RAG-FT 350. In a third and/or last round of fine-tuning and training, a third RAG-FT 354 may be performed, which may be optional, to enhance critical samples from training data 342. The critical samples may be defined based on business rules and the like, for example, if a legal team requires queries to be answered in a specific format. First RAG-FT 350, second RAG-FT 352, and third RAG-FT 354 may each utilize both outcome-based training and process-based training.

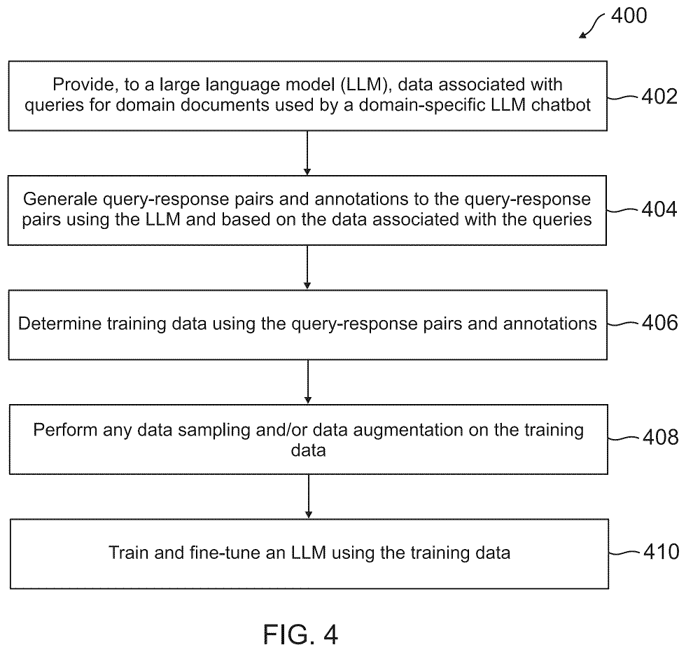

FIG. 4 is a flowchart 400 of a fine-tuning system for large language models trained for open-ended domain-specific tasks, according to an embodiment. Note that one or more steps, processes, and methods described herein of flowchart 400 may be omitted, performed in a different sequence, or combined as desired or appropriate.

At step 402 of flowchart 400, data associated with queries for domain documents used by a domain-specific LLM chatbot is provided to an LLM. Initially, one or more data samples are accessed and/or retrieved in order to detect and measure hallucinations and/or accuracy of the response(s) based on the context(s). The data sample(s) may therefore require annotations that indicate whether the response(s) properly responded to each query or other request from one or more users. However, annotations by humans may take a considerable amount of time and effort. Further, human annotations may include bias and/or may use additional information that may cause LLM hallucinations by relying on data outside the scope of the context. As such, an FT system and pipeline may be utilized to assist with fine-tuning of LLMs with the data by annotating the data and implementing LLM fine-tuning using automated and intelligent processes.

At step 404, query-response pairs and annotations to the query-response pairs are generated using the LLM and based on the data associated with the queries. Query-response pairs may be generated using different training data generation (e.g., curation and augmentation) schemes or processes. For example, with different sets of procedures and operations for training data curation and augmentation, an offline process may be used where two LLM agents may determine and optimize prompts for instructions to another LLM with a request to determine annotations and/or additional queries and responses for hallucination measurement (e.g., determination of a hallucination metric). Once the prompt is optimized, an online process may utilize the second LLM through prompting using the prompt and the data sample(s), such as the query-response pairs in the form of (query, response, context). The LLM may be prompted to utilize a CoT process to provide a CoT output, which may be assessed using another LLM to provide a decision on whether the response is accurate and/or includes a hallucination. As such, these annotations may be used to provide reasoning to the data sample(s).

At step 406, training data is determined using the query-response pairs and annotations. For a first set of procedures and operations for training data generation, such as by curating and augmenting the data sample(s) provided, the data pipeline may generate annotations automatically using an LLM and an annotator may only be required to annotate whether such a response by the LLM is accurate and/or correct. This may be done instead of asking an annotator to annotate every response, where instead the annotator need only amend a response that is incorrect. With a second set of procedures, domain documents may be used for a “doc2query” augmentation. This may include identifying question and answer pairs in domain documents for the domain associated with the data samples and annotations, where a source document for each pair may be identified and used for determination of further query-response pairs that are annotated based on whether that source document is retrieved for each response. These procedures and operations may be performed separately or combined such that an initial training data set is determined.

At step 408, data sampling and/or data augmentation is performed on the training data. After determination of the training data set, sampling may be applied to ensure that a sufficient data distribution is covered. This may be done to mimic actual online traffic and/or coverage of actual user questions and LLM chatbot response. Augmentation may be performed to provide diversity and/or missing scenario coverage of human annotated data. This may include providing query, context, and/or response diversity, such as by using additional LLMs and/or prompts to create new samples from the original data.

At step 410, an LLM is trained and fine-tuned using the training data. During training, a size of the training data may be analyzed and compared to a threshold to determine a process and/or scheme for training. For example, QA FT, a RAG FT, and/or a continuous FT may be used for the training and fine-tuning of an LLM. If the total training size meets or exceeds the threshold, then RAG fine-tuning in a continuous manner (e.g., utilizing continuous fine-tuning with RAG FT) may be used, where each iteration of the training is performed using a subset of the training data. However, if at or below the threshold, QA fine-tuning may be used first, and the RAG fine-tuning applied. Using RAG FT allows for both outcome-based training and process-based training to be used based on fine-tuning performance. As such, an LLM may be fine-tuned and trained in a faster and more efficient manner with less human intervention and efforts, further reducing human bias and making LLM fine-tuning and training more accurate and effective.

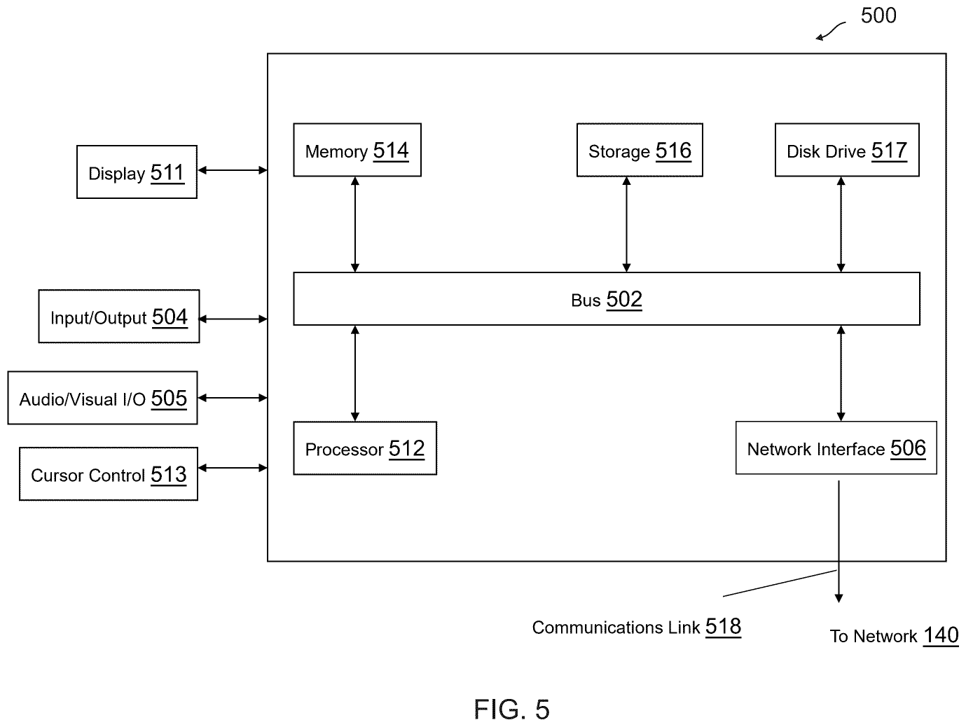

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
providing a data sample comprising a query and a context of the query to a first large language model (LLM) using an LLM prompt, wherein the LLM prompt causes the first LLM to generate a response to the query;
determining, based on the providing, the response and an annotation to the response that indicates a relevancy of the response to the query in the context of the query;
generating, based at least on the data sample, the annotation, and a plurality of other annotated data samples, a training data set usable to train a second LLM using a fine-tuning technique;
performing a data sampling and a data augmentation on the training data set;
updating the training data set based on the data sampling and the data augmentation performed; and
training the second LLM using the updated training data set and the fine-tuning technique, wherein the fine-tuning technique is applied to the second LLM when training based on a number of data samples in the updated training data set.

2. The method of claim 1, wherein the context is associated with a domain of data in which the query is requested for the response from a chatbot, and wherein the chatbot provides domain-specific responses based on domain knowledge associated with a plurality of domain documents corresponding to the domain of data.

3. The method of claim 2, wherein providing the data sample to the first LLM using the LLM prompt comprises:
generating, using a retrieval augmented generation (RAG) operation of the first LLM, the response based on the query and the plurality of domain documents.

4. The method of claim 1, wherein the determining the response and the annotation comprises:
receiving the annotation, wherein, when the relevancy indicates that the response is not relevant to the query, the annotation further includes an amendment to the response; and
creating the data sample including an information set indicating the prompt, the query, the context, one of the responses or the amendment to the response, and a label corresponding to the relevancy from the annotation.

5. The method of claim 1, wherein the fine-tuning technique includes at least one of a question-answering (QA) fine-tuning, a RAG fine-tuning, or a continuous fine-tuning, and wherein the RAG fine-tuning is utilizable with an outcome-based training and a process-based training for the training the second LLM.

6. The method of claim 5, wherein, when the number of data samples is less than or equal to a threshold number, the training the second LLM uses the QA fine-tuning before the RAG fine-tuning, or wherein, when the number of data samples is greater than or equal to the threshold number, the training the second LLM uses RAG fine-tuning with the continuous fine-tuning during a plurality of iterations of the training the second LLM.

7. The method of claim 5, wherein the outcome-based training uses a requested response to each query from the training data set during a fine-tuning loss computation, and wherein the process-based training uses a chain-of-thought (CoT) reasoning response during the fine-tuning loss computation.

8. The method of claim 1, wherein the data augmentation comprises at least one of a query augmentation, a response augmentation, or a context augmentation.

9. A method comprising:
providing a plurality of domain documents with document metadata to a first large language model (LLM) using an LLM prompt, wherein the LLM prompt causes the first LLM to generate a plurality of query-response pairs based on the document metadata;
determining, based on the providing, the plurality of query-response pairs each corresponding to a source document of the plurality of domain documents;
generating a plurality of additional queries from at least one of the source documents or a plurality of top-n documents retrieved for each query of the plurality of query-response pairs;
generating, based at least on the plurality of query-response pairs and the plurality of additional queries, a training data set usable to train a second LLM using a fine-tuning technique;
performing a data sampling and a data augmentation on the training data set;
updating the training data set based on the data sampling and the data augmentation performed; and
training the second LLM using the updated training data set and the fine-tuning technique, wherein the fine-tuning technique is applied to the second LLM when training based on a number of data samples in the updated training data set.

10. The method of claim 9, wherein, prior to generating the training data set, the method further comprises:
identifying the plurality of top-n documents retrieved for each query in the plurality of query-response pairs; and
determining whether the source document is among the plurality of top-n documents,
wherein, when the source document is among the plurality of top-n documents, a corresponding one of the plurality of query-response pairs and one or more corresponding queries of the plurality of additional queries are annotated with a positive response annotation, or wherein, when the source document is not among the plurality of top-n documents, a corresponding one of the plurality of query-response pairs and one or more corresponding queries of the plurality of additional queries are annotated with a negative response annotation.

11. The method of claim 10, further comprising:
generating contrasting retrieval augmented generation (RAG) data sets based on the determining whether the source document is among the plurality of top-n documents, wherein the contrasting RAG data sets include the plurality of query-response pairs indicating whether the source document was found among the plurality of top-n documents for each response in the plurality of query-response pairs.

12. The method of claim 10, wherein the first LLM generates the plurality of additional queries based on spelling deviations and grammatical deviations from each query of the plurality of query-response pairs.

13. The method of claim 9, wherein the context is associated with a domain of data in which the query is requested for the response from a chatbot, and wherein the chatbot provides domain-specific responses based on domain knowledge associated with a plurality of domain documents corresponding to the domain of data.

14. The method of claim 9, wherein the fine-tuning technique includes at least one of a question-answering (QA) fine-tuning, a RAG fine-tuning, or a continuous fine-tuning, and wherein the RAG fine-tuning is utilizable with an outcome-based training and a process-based training for the training the second LLM.

15. The method of claim 14, wherein, when the number of data samples is less than or equal to a threshold number, the training the second LLM uses the QA fine-tuning before the RAG fine-tuning, or wherein, when the number of data samples is greater than or equal to the threshold number, the training the second LLM uses RAQ fine-tuning with the continuous fine-tuning during a plurality of iterations of the training the second LLM.

16. The method of claim 14, wherein the outcome-based training uses a requested response to each query from the training data set during a fine-tuning loss computation, and wherein the process-based training uses a chain-of-thought (CoT) reasoning response during the fine-tuning loss computation.

17. The method of claim 9, wherein the data augmentation comprises at least one of a query augmentation, a response augmentation, or a context augmentation.

18. A service provider system comprising:
a non-transitory memory; and
one or more hardware processors coupled to the non-transitory memory and configured to read instructions from the non-transitory memory to cause the service provider system to perform operations comprising:
generating, based a plurality of query-response pairs and annotations generated by a first large language model (LLM), a training data set usable to train a second LLM using a fine-tuning technique;
performing a data sampling and a data augmentation on the training data set;
updating the training data set based on the data sampling and the data augmentation performed; and
training the second LLM using the updated training data set and the fine-tuning technique, wherein the fine-tuning technique is applied to the second LLM when training based on a number of data samples in the updated training data set.

19. The service provider system of claim 18, wherein the annotations are generated by the first LLM using retrieval augmented generation (RAG), and wherein, subsequent to generating the annotations, a data sampling and a data augmentation is performed to generate additional query-response pairs added to the plurality of query-response pairs prior to the generating the training data set.

20. The service provider system of claim 18, wherein the annotations are generated by the first LLM using domain documents based on a source document for each of the plurality of query-response pairs.
